(19) United States
(12) Patent Application Publication
(10) Pub. No.: US 2006/0064523 A1
(43) Pub. Date: Mar. 23, 2006

(54) Control method for virtual machine

(76) Inventors: Toshiomi Moriki, Kunitachi (JP); Yuji Tsushima, Hachioji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/195,742

(22) Filed: Aug. 3, 2005

(30) Foreign Application Priority Data
Sep. 17, 2004 (JP) 2004-271127

(51) Int. Cl. G06F 13/38

(52) U.S. Cl. 710/62

(57) ABSTRACT

An object of this invention is to prevent logical partitions used by users from being affected by faults or errors in I/O devices. According to this invention, in an I/O device control method in which I/O devices connected to a computer are allocated among a plurality of logical partitions constructed of a hypervisor (10), the hypervisor (10) sets the logical partitions as a user LPAR to be provided to a user and as an I/O LPAR for controlling an I/O device, allocates the I/O device to the I/O LPAR, and an association between the user LPAR and the logical I/O LPAR is set by an I/O device table.

### CLAIM OF PRIORITY

The present application claims priority from Japanese application JP 2004-271127 filed on Sep. 17, 2004, the content of which is hereby incorporated by reference into this application.

### BACKGROUND

This invention relates to a virtual machine system, and more particularly to a technique of allocating I/O devices to a plurality of logical partitions.

In a virtual machine system that provides OSs on a plurality of logical partitions, the OSs on the individual logical partitions access physical I/O devices to use or share the I/O devices.

In a known example in which OSs on a plurality of logical partitions use I/O devices, when an OS on a first logical partition accesses an I/O device, the OS sends an I/O request to an OS on a second logical partition and then the second logical partition's OS accesses the I/O device. Then, the result of the I/O access is transferred to the first logical partition's OS through a memory shared by the first and second logical partitions (for example, see US 2002-0129172 A).

Also, in a virtual machine system in which a plurality of guest OSs are provided on a host OS, the guest OSs operate as applications of the host OS, and the host OS collectively processes I/O requests from the guest OSs to allow an I/O device to be shared (for example, see U.S. Pat. No. 6,725,289 B).

### SUMMARY

In conventional examples like US 2002-0129172 A, it is necessary to make the OSs on the logical partitions recognize the shared memory as a virtual I/O device. This requires modifying the I/O portions of the OSs and preparing particular I/O device drivers for the OSs, which limits the kinds of supportable I/O devices. Furthermore, in US 2002-0129172 A, when a fault or an error occurs in an I/O device, it will affect the OS on the second logical partition that relays I/O access between the first logical partition and the I/O device, which may then bring the OS to a halt.

In conventional examples like U.S. Pat. No. 6,725,289 B, the guest OSs, operating as applications of the host OS, are capable of using I/O device drivers prepared for individual guest OSs. It is therefore possible to deal with a wide variety of I/O devices by using, e.g., Windows or LINUX as the guest OSs. However, when a fault or an error occurs in an I/O device, it may affect or even halt the host OS, and may further halt access to other I/O devices.

This invention has been made to solve the problems above, and an object of this invention is to prevent logical partitions used by users from being affected by faults or errors in I/O devices.

According to this invention, in an I/O device control method in which I/O devices connected to a computer are allocated among a plurality of logical partitions constructed on a computer control program, the control program sets the logical partitions as a logical user partition provided to a user and as a logical I/O partition for controlling an I/O device, allocates the I/O device to the logical I/O partition, and sets the association between the logical user partition and the logical I/O partition.

A user OS used by a user is booted on the logical user partition, an I/O OS for accessing the I/O device is booted on the logical I/O partition; and communication is performed between the user OS and the I/O OS based on the association.

Thus, according to this invention, the logical user partition used by a user and the logical I/O partition having the I/O device are independently constituted, so that, when a fault or an error occurs in the I/O device, the fault or error is prevented from spreading to affect the logical user partition.

Particularly, the user OS used by a user runs in the logical user partition and the I/O OS for accessing the I/O device runs in the logical I/O partition, and therefore a fault or an error of the I/O device only affects the I/O OS but is prevented from affecting and halting the user OS.

### BRIEF DESCRIPTION OF THE DRAWINGS

FIG. 1 is a block diagram showing a hardware configuration of a physical computer that realizes virtual machines according to a first embodiment of this invention.

FIG. 2 is a block diagram showing a software configuration of the virtual machine system according to the first embodiment of this invention.

FIG. 3 is an illustrative diagram showing an example of an I/O device table.

FIG. 4 is an illustrative diagram of a memory mapped I/O showing an example of virtual devices.

FIG. 5 is a block diagram showing the entire function of the virtual machine system.

FIG. 6 is a flowchart showing a process performed in the virtual machine system when a fault occurs.

FIG. 7 is a flowchart showing a process performed in the virtual machine system when an I/O device is hot-plugged.

FIG. 8 is a flowchart showing a process performed in the virtual machine system when I/O access is made.

FIG. 9 is a flowchart showing a process performed in the virtual machine system when an I/O device is hot-removed.

FIG. 10 is a block diagram showing the entire function of a virtual machine system according to a second embodiment.

FIG. 11 is a block diagram showing the entire function of a virtual machine system according to a third embodiment.

FIG. 12 is a block diagram showing the entire function of a virtual machine system according to a fourth embodiment.

### DESCRIPTION OF THE PREFERRED EMBODIMENTS

Embodiments of this invention will now be described referring to the accompanying drawings.

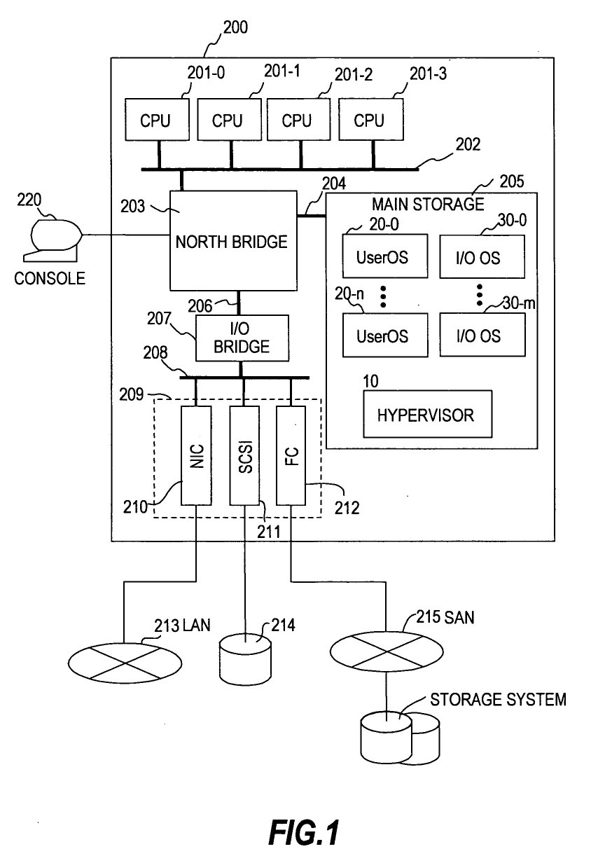

FIG. 1 shows a configuration of a physical computer 200 that runs a virtual machine system according to a first embodiment of this invention.

The physical computer 200 includes a plurality of CPUs 201-0 to 201-3, and these CPUs are connected to a north bridge (or a memory controller) 203 through a front-side bus 202.

The north bridge 203 is connected to a memory (main storage) 205 through a memory bus 204 and to an I/O bridge 207 through a bus 206. The I/O bridge 207 is connected to I/O devices 209 through an I/O bus 208 formed of a PCI bus or PCI Express. The I/O bus 208 and the I/O devices 209 support hot plugging (hot-add/hot-remove).

The CPUs 201-0 to 201-3 access the memory 205 through the north bridge 203, and the north bridge 203 accesses the I/O devices 209 through the I/O bridge 207 to conduct desired processing.

While the north bridge 203 controls the memory 205, the north bridge 203 contains a graphic controller and is connected to a console 220 so as to display an image.

The I/O devices 209 include a network adapter (hereinafter referred to as an NIC) 210 connected to a LAN 213, an SCSI adapter (hereinafter referred to as an SCSI) 211 connected to a disk device 214 etc., and a fiber channel adapter (hereinafter referred to as an FC) 212 connected to a SAN (Storage Area Network), for example. The NIC 210, the SCSI 211, and the FC 212 are accessed by the CPUs 201-0 to 201-3 through the I/O bridge 207.

The physical computer 200 may include a single CPU or two or more CPUs.

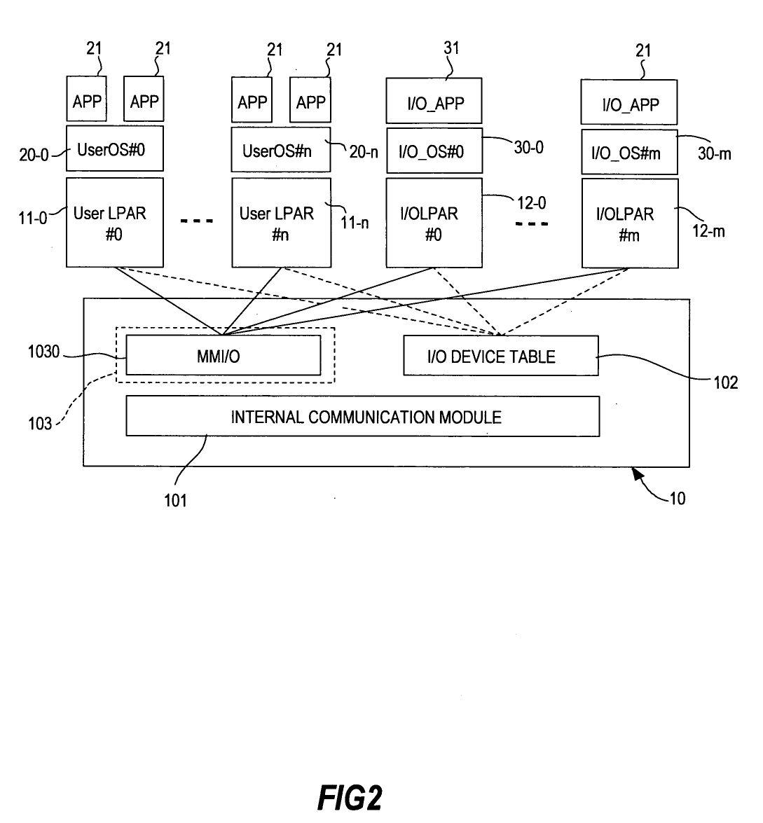

Next, referring to FIG. 2, the software for realizing virtual machines on the physical computer 200 will be described in detail.

In FIG. 2, a hypervisor (firmware or middleware) 10 runs on the physical computer 200 to logically partition hardware resources (computer resources) and to control the logical partitions (LPARs: Logical PARtitions). The hypervisor 10 is control software that divides the physical computer 200 into a plurality of logical partitions (LPARs) and controls the allocation of computer resources.

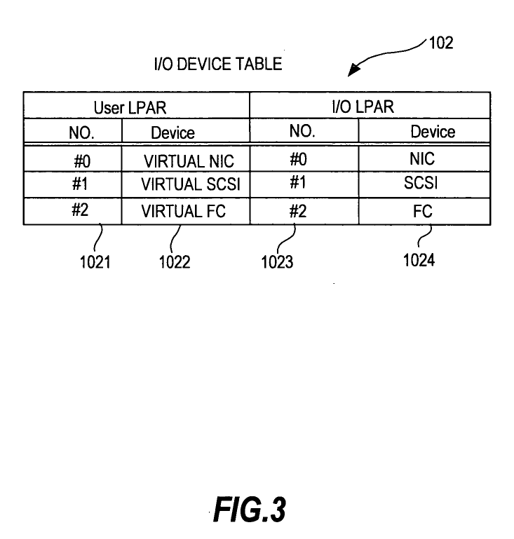

The hypervisor 10 divides the computer resources of the physical computer 200 into user LPARs #0 to #n (11-0 to 11-n in FIG. 2) as logical partitions provided to users, and I/O_LPARs #0 to #m (12-0 to 12-m in FIG. 2) as logical partitions for accessing the physical I/O devices 209. While the number of user LPARs #0 to #n can be any number determined by an administrator or the like, the number of I/O_LPARs #0 to #m is set equal to the number of the I/O devices 209. In other words, the I/O devices and the I/O_LPARs are in a one-to-one correspondence, and, for example, when the I/O devices 209 include three elements as shown in FIG. 1, three I/O_LPARs #0 to #2 are created as shown in FIG. 3, where the NIC 210 is associated with the I/O_LPAR #0, the SCSI 211 is associated with the I/O_LPAR #1, and the FC 212 is associated with the I/O_LPAR #2. The I/O_LPARs #0 to #2 independently access the NIC 210, the SCSI 211, and the FC 212, respectively.

To be specific, the I/O_LPAR #0 makes access only to the NIC 210, the I/O_LPAR #1 makes access to the SCSI 211, and the I/O_LPAR #2 makes access to the FC 212. Each of the I/O_LPARs #0 to #2 thus makes access only to a single I/O device. The I/O devices are thus allocated to the I/O_LPARs #0 to #2 so that overlapping access to the I/O devices will not occur.

The user LPARs #0 to #n respectively contain OSs 20-0 to 20-n used by users (hereinafter referred to as user OSs), and user applications 21 are executed on the user OSs.

In the I/O_LPARs #0 to #m, their respective I/O_OSs (30-0 to 30-m in FIG. 2) are run to access the I/O devices in response to I/O access from the user OSs 20-0 to 20-n.

As will be fully described later, the hypervisor 10 processes communication between associated user OSs and I/O_OSs to transfer I/O access requests from the user OSs to the I/O_OSs, and the I/O_OSs access the I/O devices 209. Then, by allocating the plurality of user LPARs #0 to #n to one of the I/O_LPARs #0 to #m, the plurality of user OSs #0 to #n can share the I/O device 209.

Thus, as will be described later, an I/O device table 102 is used to define which user OSs on the user LPARs #0 to #n use which I/O devices, and the associations between the user LPARs #0 to #n and the I/O_LPARs #0 to #m defined on the I/O device table 102 determine the relation between the user OSs #0 to #n and the I/O devices 209.

Also, in each of the I/O_OSs 30-0 to 30-m, an I/O application 31 is executed, as will be described later, to transfer an access request between a communication driver and a device driver of the I/O_OS.

The hypervisor 10 includes an internal communication module 101 that processes communication between the user LPARs #0 to #n and the I/O_LPARs #0 to #m, the above-mentioned I/O device table 102 that defines which user LPARs #0 to #n use which I/O devices, and virtual devices 103 that are accessed as I/O devices from the user LPARs #0 to #n.

The internal communication module 101 connects the user LPARs #0 to #n and the I/O_LPARs #0 to #m to enable communication between them.

The virtual devices 103 transfer commands and data between the user LPARs #0 to #n and the I/O_LPARs #0 to #m, where the virtual devices 103 look like the real I/O devices 209 from the user OSs #0 to #n.

The virtual devices 103 are therefore provided with a virtual memory mapped I/O and virtual interrupt interface and are capable of behaving as the real I/O devices 209 seen from the user OSs #0 to #n. The virtual interrupt interface accepts interrupts according to I/O access requests from the user OSs and gives notification to the user LPARs.

As shown in FIG. 3, the I/O device table 102, for setting which user LPARs #0 to #n use which I/O devices, is configured. Each row in the I/O device table 102 of FIG. 3 includes a field 1021 for setting the number of a single user LPAR, a field 1023 for setting the number of an I/O_LPAR as an I/O device allocated to the user LPAR, a field 1024 for setting the name (or address) of the real I/O device that corresponds to the I/O_LPAR number, and a field 1022 for setting the name (or address) of the virtual device 103 that corresponds to the real I/O device.

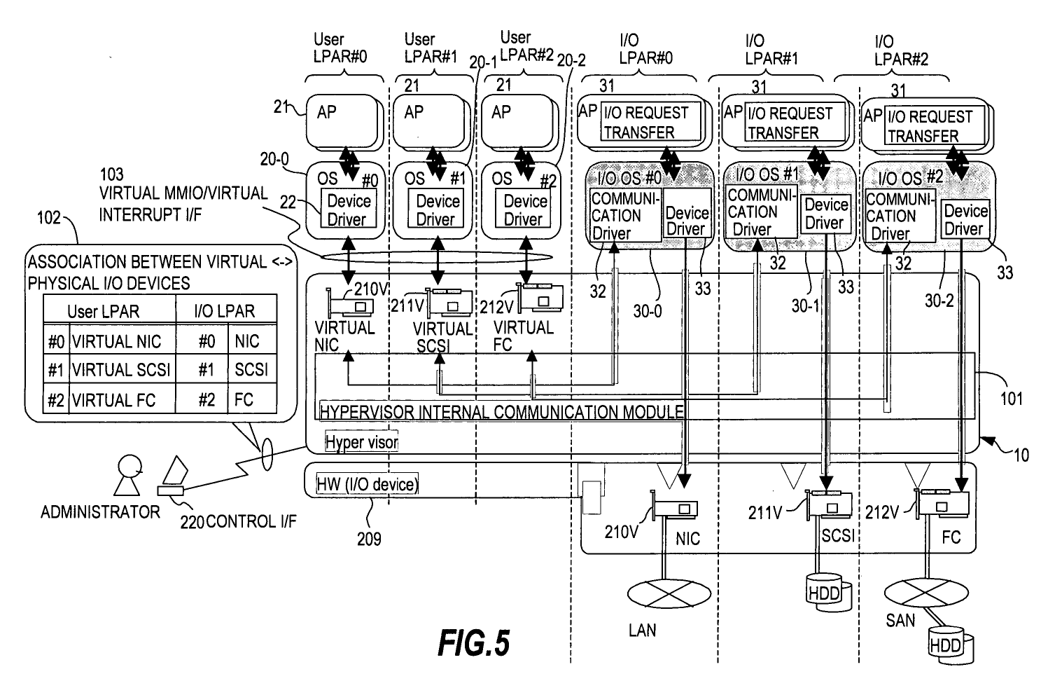

FIG. 3 shows the associations between the user LPARs and the I/O_LPARs shown in FIG. 5 described later. In this example, the user LPAR #0 uses the NIC 210, and so # is set as the number of the I/O_LPAR that corresponds to the NIC 210 and Virtual NIC is set as the virtual device that corresponds to the NIC 210.

The user LPARs #0 to #n and the I/O_LPARs #0 to #m read the I/O device table 102, and thus the user LPARs #0 to #n share the I/O devices 209, and I/O requests from the user OSs #0 to #n are thus controlled.

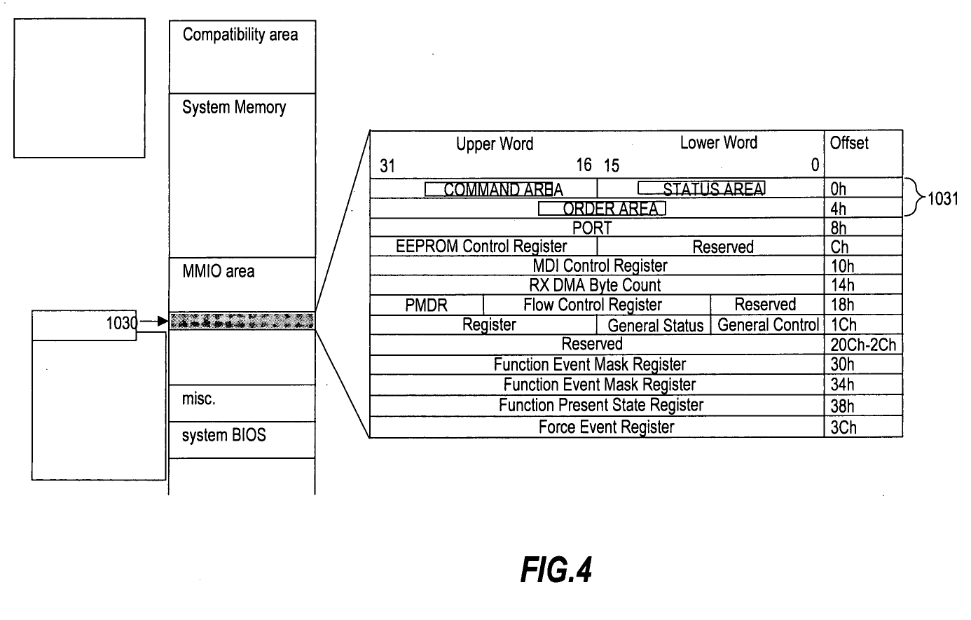

Next, FIG. 4 shows an example of the virtual devices 103, where the virtual devices 103 are configured with a virtual memory mapped I/O (hereinafter referred to as MM I/O).

The virtual MM I/O 1030, constituting the virtual devices 103, is set in a given area on the memory 205. With a given region of the virtual MM I/O 1030 being a control block (control register) 1031, the user OSs #0 to #n and the I/O_LPARs #0 to #m write commands, statuses, and orders in the control block 1031 to transfer I/O access requests from the user OSs #0 to #n and responses from the real I/O devices 209.

Next, the outlines of I/O access requests from the user OSs #0 to #n will be described below.

With I/O access requests from applications 21, for example, the user OSs #0 to #n on the user LPARs access the virtual devices 103 (virtual MM I/O) which the user OSs #0 to #2 provide, and the user OSs #0 to #n refer to the I/O device table 102 to specify the I/O_LPARs that correspond to the virtual devices 103, and then notify the I/O_OSs #0 to #m about the access made to the virtual devices 103.

Receiving the notification, the I/O_OSs #0 to #m read, from the virtual devices 103, the requests from the user OSs #0 to #n, through their communication drivers, I/O applications 31, and device drivers described later, and then make access to the I/O devices 209.

Then, the I/O_OSs #0 to #m notify the virtual devices 103 of the results of the access made to the I/O devices, and thus complete the series of I/O access operations.

In this way, as will be described later, a user OS makes access not directly to the physical I/O device 209 but to the virtual device 103 on the hypervisor 10, and then the I/O_OS gives the access to the real I/O device 209. Therefore, even when a fault or an error occurs in an I/O device, the user OS is not affected by the fault or error of the I/O device, though the I/O_OS may be affected, which certainly prevents the user OS from halting.

While the description above has shown an example in which the virtual devices 103 are realized with MM I/O, the virtual devices 103 may be realized with a virtual I/O register, for example.

FIG. 5 shows an example of virtual machines having the configuration of FIG. 1, where three user LPARs #0 to #2 use three I/O devices.

Because there are three devices as the I/O devices 209, the hypervisor 10 creates three I/O_LPARs #0 to #2. Then, the hypervisor 10 allocates the I/O_LPAR #0 to the NIC 210, the I/O_LPAR #1 to the SCSI 211, and the I/O_LPAR #2 to the FC 212.

Also, the hypervisor 10 creates a given number of user LPARs according to, e.g., an instruction from an administrator. It is assumed here that the hypervisor 10 creates three user LPARs #0 to #2. Then, the hypervisor 10 determines which user LPARs use which I/O devices on the basis of, e.g., an instruction from the administrator, and generates or updates the I/O device table 102 shown in FIG. 3.

Now, in determining which user LPARs use which I/O devices, the administrator, from the console 220, causes a monitor etc. to display the I/O device table 102 of FIG. 3 as a control interface, and sets the relation between the user LPARs and the I/O_LPARs.

In this example, the user OS #0 uses the NIC 210, the user OS #1 uses the SCSI 211, and the user OS #2 uses the FC 212. An I/O device may be shared by a plurality of user OSs. The control interface in the drawing shows an example in which the image of the I/O device table 102 shown in FIG. 3 is processed with a GUI. A CUI (Character User Interface), as well as a GUI, may be used for the control interface.

With an I/O access request from the application 21, the user OS #0 makes access from the device driver 22 to the virtual NIC 210V on the user LPAR #0. The virtual NIC 210V is a virtualization of the real NIC 210 on the user LPAR #0, which is provided by the MM I/O and virtual interrupt interface described above.

The hypervisor 10 transfers the I/O access request to the I/O_OS #0 on the I/O_LPAR #0 that controls the entity of the virtual NIC 210V. This transfer is performed by the communication driver 32 of the I/O_OS #0. The communication driver 32 notifies the I/O application 31 of the access request, and the I/O application 31 transfers the access request, received by the communication driver 32, to the device driver 33, and the device driver 33 accesses the NIC 210 as the physical I/O device.

The result of the I/O access is sent by the reverse route, i.e., from the device driver 33 of the I/O_OS #0 to the virtual NIC 210V on the user LPAR #0 through the communication driver 32, and further to the user OS #0.

Similarly to the user OS #0, the user OS #1 makes I/O access to the real SCSI 211 through the device driver 22 of the user OS #1, the virtual SCSI 211V as a virtualization of the real SCSI 211 on the user LPAR #1, the communication driver 32 of the I/O_OS, the I/O application 31, and the device driver 33.

Also, similarly to the user OS #0, the user OS #2 makes I/O access to the real FC 212 through the device driver 22 of the user OS #2, the virtual FC 212V as a virtualization of the real FC 212 on the user LPAR #2, the communication driver 32 of the I/O_OS, the I/O application 31, and the device driver 33.

The device drivers 22 of the user OSs #0 to #2 and the device drivers 33 of the I/O_OSs #0 to #2 can be those provided by the user OSs #0 to #2 and the I/O_OSs #0 to #2, and so it is possible to deal with a variety of I/O devices 209 without a need to create specific drivers.

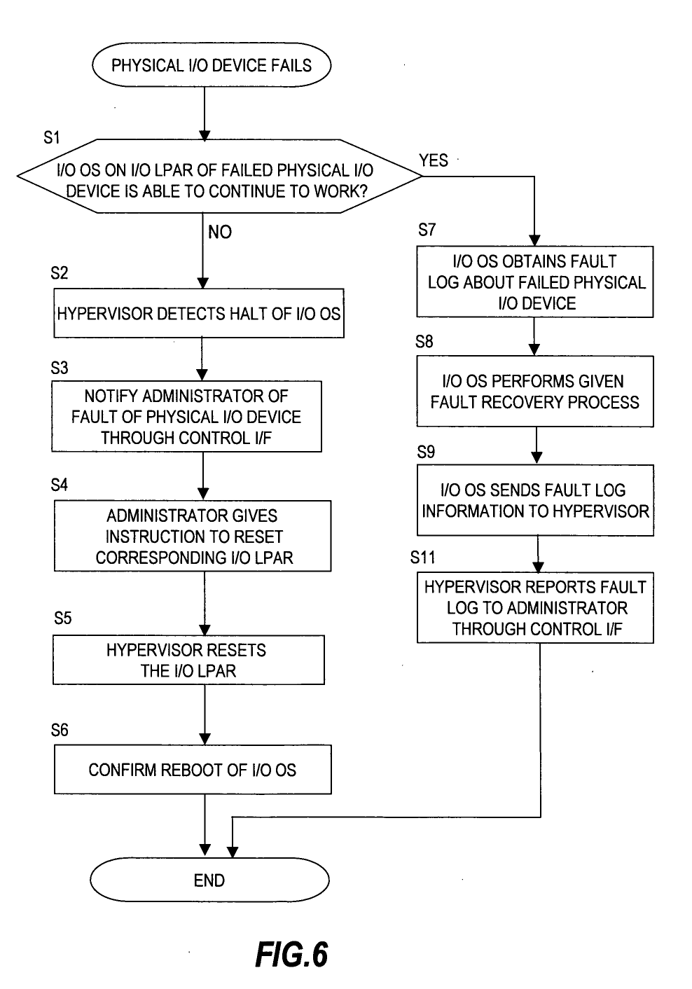

FIG. 6 is a flowchart showing a process that is performed in the physical computer 200 (virtual machine system) when an I/O device 209 (any of the NIC 210, SCSI 211, and FC 212) fails.

For example, when a timeout of a response to an I/O access request occurs in some I/O device 209, the hypervisor 10 judges that the I/O device 209 has failed and performs the process steps below.

In a step S1, on the basis of the I/O device table 102, the hypervisor 10 specifies the I/O_LPAR to which the physical I/O device 209 belongs, and judges whether the I/O_OS on that I/O_LPAR is able to continue to work. For example, the hypervisor 10 sends an inquiry to the I/O_OS and makes the judgement according to whether the I/O_OS gives a response.

When judging that the corresponding I/O_OS is unable to continue to work, the flow moves to a step S2, and when judging the I/O_OS is able to continue to work, it moves to a step S7.

In the step S2, the hypervisor 10 detects a halt of the corresponding I/O_OS and moves to a step S3, where, through the given control interface and from the console 220, the hypervisor 10 reports that a problem, e.g., a failure, has occurred in the I/O device controlled by the halted I/O_OS.

Next, in a step S4, the administrator gives an instruction to reset the I/O_OS from, for example, the console 220, and then the hypervisor 10 moves to a step S5 to reset the I/O_OS on the failed I/O_LPAR.

Then, it is confirmed in a step S6 that the I/O_OS, which was reset, has normally rebooted, and the process ends.

On the other hand, when it is judged in the step S1 that the I/O_OS is able to continue to work, the process moves to the step S7 and the I/O_OS that controls the failed I/O device 209 obtains a fault log about the I/O device 209. Then, the I/O_OS performs a predetermined fault recovery process in a step S8 and sends the obtained I/O device fault log to the hypervisor 10 in a step S9.

Then, in a step 11, using the given control interface and from the console 220, the hypervisor 10 indicates to the administrator the fault log obtained from the I/O_OS, so as to notify the administrator of the contents of the fault.

In this way, the LPAR where the user OS runs and the LPAR where the I/O_OS runs are different logical partitions, and therefore the fault of the I/O device 209 does not affect the user OS.

As described above, when the I/O_OS is unable to continue to work, only the corresponding I/O_OS is reset, and so the I/O_OS can reboot and the I/O device 209 can recover without a need to halt services that the application 21 on the user OS provides. On the other hand, when the failed I/O_OS is able to continue to work, the hypervisor 10 automatically notifies the administrator about the fault condition of the I/O device 209, which facilitates the maintenance and management of the virtual machine.

While the description above has shown an example in which the administrator gives an instruction to reset an I/O_OS halted by a fault, the hypervisor 10 may give the instruction to reset.

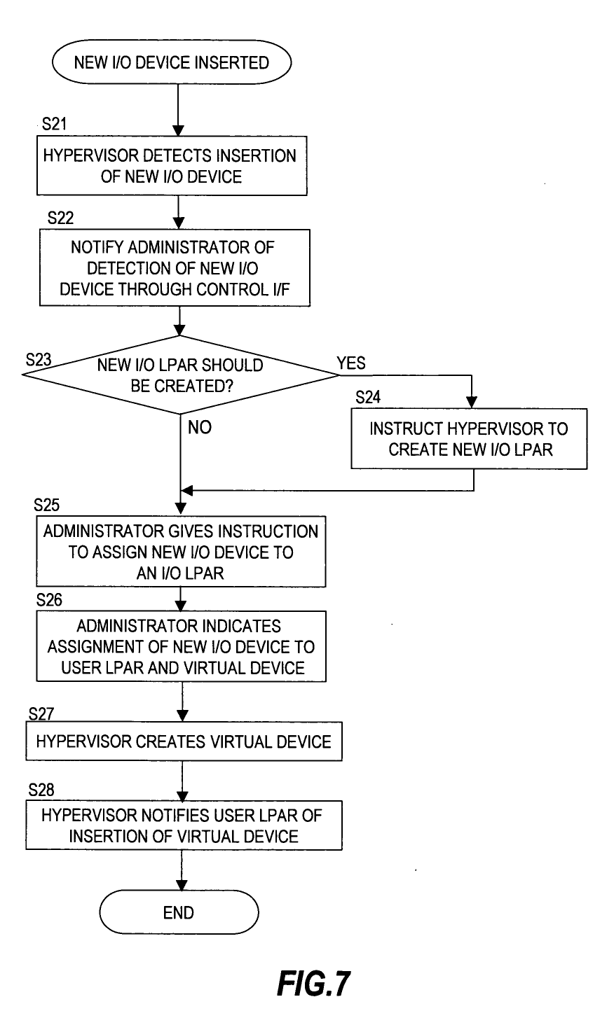

FIG. 7 is a flowchart showing an example of a process performed in the physical computer 200 when a new I/O device 209 is inserted (hot-added) in the I/O bus 208.

In a step S21, the hypervisor 10, monitoring the I/O bus 208, detects the addition of the new I/O device and moves to a step S22.

In the step S22, through the given control interface and from the console 220, for example, the administrator is notified of the detection of the new I/O device. In a step S23, the administrator gives an instruction indicating whether to create an I/O_LPAR for the new I/O device. When an I/O_LPAR should be created, the administrator instructs the hypervisor 10 to create an I/O_LPAR for the new I/O device, and otherwise the process moves to a step S25.

In a step S24, the hypervisor 10 creates an I/O_LPAR corresponding to the new I/O device.

In the step S25, on the basis of an instruction from the administrator, the new I/O device is allocated to an I/O_LPAR. That is to say, on the I/O device table 102, the number of the I/O_LPAR is set in the field 1023 and the I/O device name is set in the field 1024, with the user LPAR fields 1021 and 1022 in the same row being left blank.

In a step S26, the allocation of the new I/O device to a user LPAR is determined on the basis of an instruction from the administrator. In other words, on the I/O device table 102, in the row where the user LPAR fields are left blank, a user LPAR and a virtual device 103 are allocated to the I/O_LPAR associated with the new I/O device.

Then, in a step S27, the hypervisor 10 creates a virtual device 103 for the physical I/O device. Then, in a step S28, the hypervisor 10 notifies the user LPAR which was allocated in the step S26 that the new virtual device 103 has been added.

When the new I/O device is allocated to a new I/O_LPAR, the hypervisor 10 boots a new I/O_OS. The user OS can then use the optionally added, new I/O device.

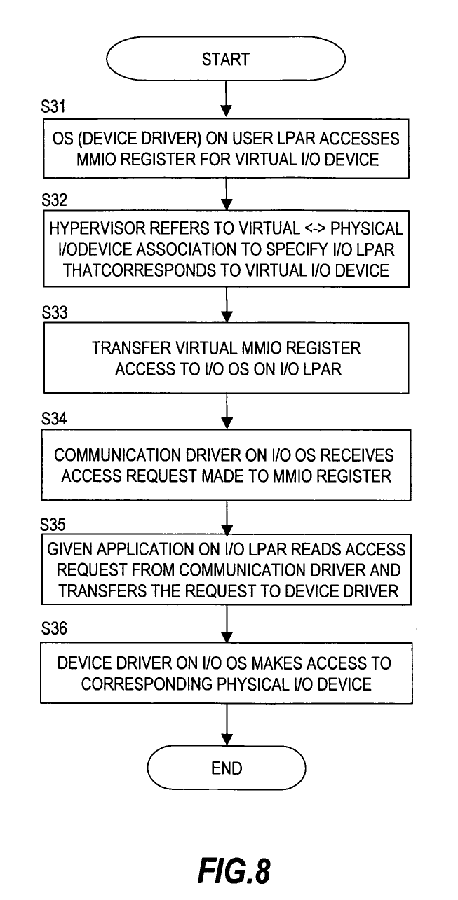

FIG. 8 is a flowchart showing an example of a process performed in the physical computer 200 when a user LPAR makes an I/O access request.

In a step S31, with an I/O access request, the device driver of the user OS running on the user LPAR accesses the control block 1031 of the virtual MM I/O 1030 as a virtual device 103 (the virtual NIC 210V etc.).

In a step S32, the hypervisor 10 refers to the I/O device table 102 that defines the associations between virtual devices and physical I/O devices, so as to specify the I/O_LPAR that corresponds to the accessed virtual device.

In a step S33, the hypervisor 10 transfers the access to the I/O_OS on the I/O_LPAR that corresponds to the accessed virtual MM I/O.

In a step S34, the communication driver 32 of the I/O_OS receives the access request made to the virtual MM I/O 1030 and obtains the contents of the virtual MM I/O 1030.

Next, in a step S35, the I/O application 31 on the I/O_OS, which has received the report of receipt from the communication driver 32, reads the access request from the communication driver 32 and transfers the access request to the device driver 33 that controls the I/O device.

In a step S36, the I/O_OS's device driver 33 executes the access to the physical I/O device.

Through these operations, the access from the user OS to the physical I/O device 209 is sent through the virtual device 103, the communication driver 32 incorporated in the I/O_OS of the I/O_LPAR, the I/O application 31, and the device driver 33.

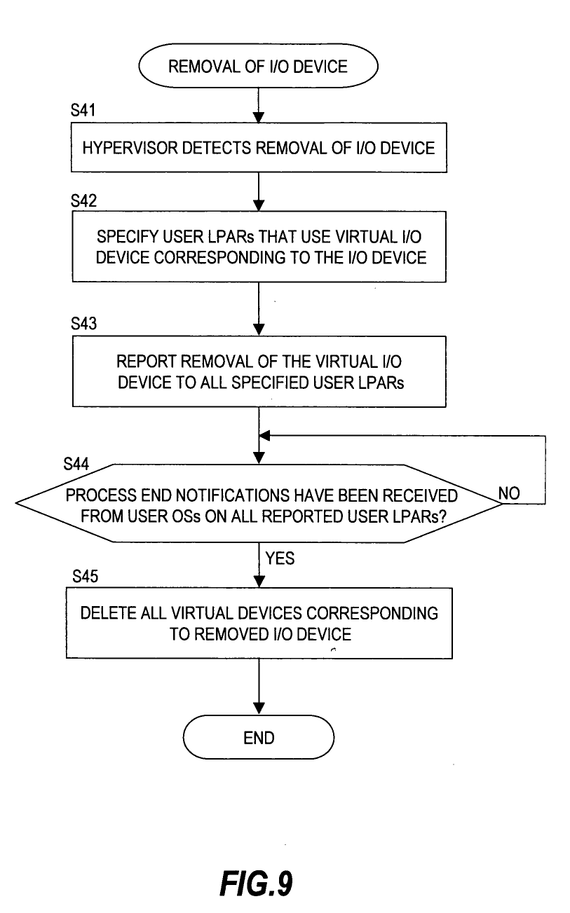

Next, FIG. 9 is a flowchart showing an example of a process performed in the physical computer 200 when an I/O device 209 is removed (hot-removed) from the I/O bus 208.

In a step S41, the hypervisor 10, monitoring the I/O bus 208, detects the removal of the I/O device and moves to a step S42.

In the step S42, the hypervisor 10 specifies the I/O_LPAR and virtual device 103 that correspond to the removed I/O device, and further specifies user LPARs that use the I/O_LPAR.

In a step S43, all user OSs that use the removed I/O device are notified of the removal of the virtual device 103.

Then, it is checked in a step S44 whether the user OSs on all user LPARs from which the virtual device 103 is removed have completed a process for the removal of the virtual device 103, and the flow waits until all user OSs complete the removal process.

When all user OSs have completed the process for the removal of the virtual device 103, the virtual device 103 that corresponds to the removed I/O device is deleted in a step S45 and the process ends.

Thus, the virtual device 103 is deleted after the user OSs on the user LPARs have completed the removal process, which enables safe removal of the I/O device.

### Second Embodiment

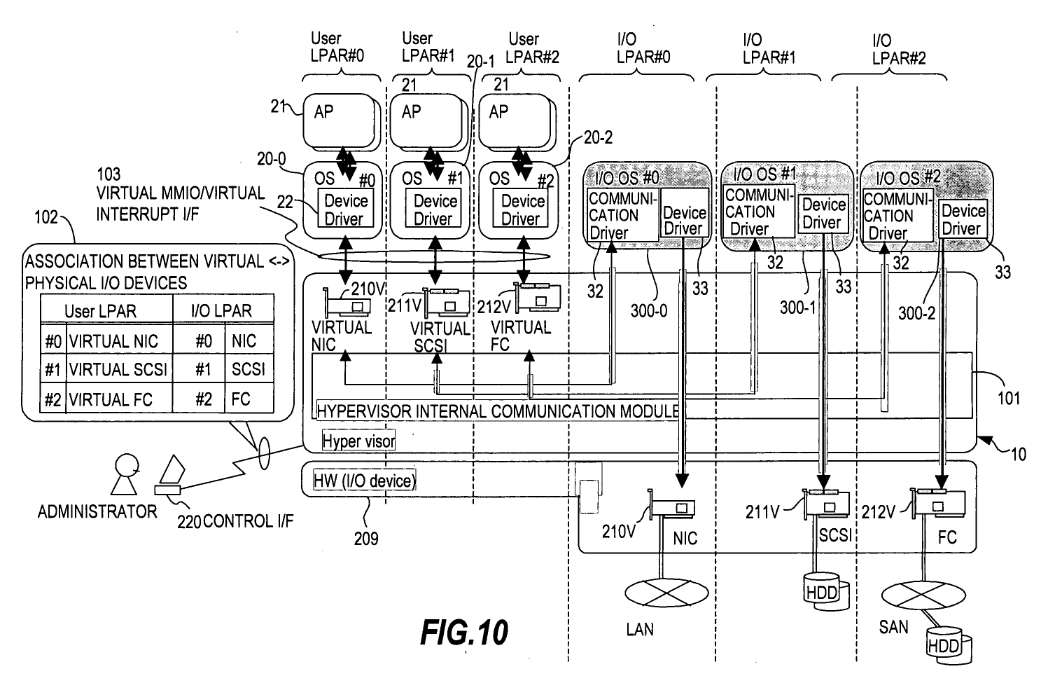

FIG. 10 shows a second embodiment, where, in the configuration of the first embodiment, the function of the I/O applications 31, which relay I/O access between the communication drivers 32 and the device drivers 33, is incorporated in the I/O_OSs #0 to #2 of FIG. 5, and so the I/O applications 31 are not needed.

The I/O_OS #0′ (300-0 in FIG. 10) on the I/O_LPAR #0 that accesses the NIC 210 has a function to transfer I/O access between the communication driver 32 that communicates with the virtual NIC 210V on the user LPAR #0 and the device driver 33 that makes real I/O access to the NIC 210.

Similarly, the I/O_OS #1′ (300-1 in FIG. 10) on the I/O_LPAR #1 that accesses the SCSI 211 has a function to transfer I/O access between the communication driver 32 that communicates with the virtual SCSI 211V on the user LPAR #1 and the device driver 33 that makes real I/O access to the SCSI 211.

Further, the I/O_OS #2′ (300-2 in FIG. 10) on the I/O_LPAR #2 that accesses the FC 212 has a function to transfer I/O access between the communication driver 32 that communicates with the virtual FC 212V on the user LPAR #2 and the device driver 33 that makes real I/O access to the FC 212.

In this case, as in the first embodiment, it is possible to prevent the user OSs #0 to #2 from halting even when an I/O device fails, thereby providing virtual machines with high reliability.

### Third Embodiment

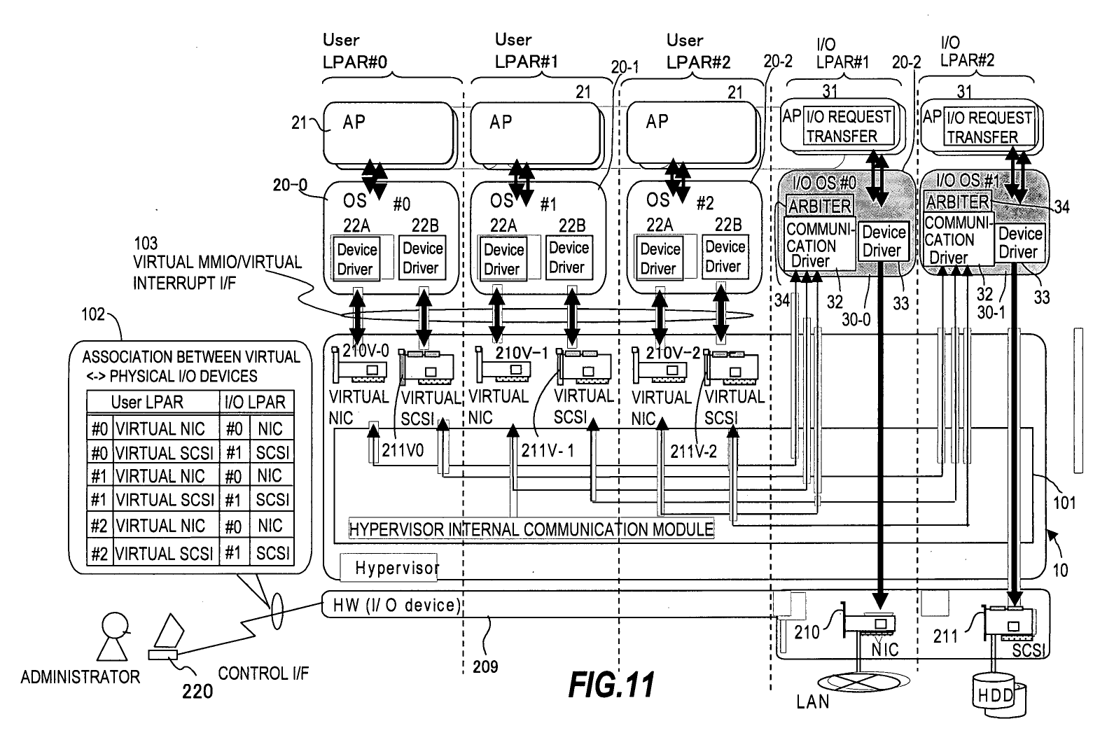

FIG. 11 shows a third embodiment, where, in the configuration of the first embodiment, the NIC 210 and the SCSI 211 are shared by the three user OSs #0 to #2. In FIG. 11, the same components as those of the first embodiment are shown at the same reference characters and are not described again here.

In the I/O device table 102, the I/O LPAR #0 having the NIC 210 and the I/O LPAR #1 having the SCSI 211 are allocated to each of the user LPARs #0 to #2.

According to the allocation of the I/O LPARs #0 and #1 in the I/O device table 102, the hypervisor 10 creates, for the user LPARs #0 to #2, virtual NICs 210V-0 to 210V-2 as virtual devices 103 and also creates virtual SCSIs 211V-0 to 211V-2.

Then, device drivers 22A and 22B that correspond to the virtual NICs 210V-0 to 210V-2 and the virtual SCSIs 211V-0 to 211V-2 are respectively incorporated in the user OSs #0 to #2.

In the I/O_OS #0 on the I/O LPAR #0 that makes I/O access to the NIC 210, an arbiter 34 functions to determine with which of the virtual NICs 210V-0 to 210V-2 of the user LPARs #0 to #2 the I/O access should be made.

For example, when the user OS #0 is making I/O access with the I/O_OS #0 through the virtual NIC 210V-0 on the user LPAR #0, the arbiter 34 places access from other user OSs #1 and #2 (the user LPARs #1 and #2) in the wait state. Then, after the I/O access from the user OS #0 has ended, the arbiter 34 accepts I/O access from other user OS #1 or #2.

Similarly, in the I/O_OS #1 on the I/O LPAR #1 that makes I/O access to the SCSI 211, the arbiter 34 functions to determine with which of the virtual SCSIs 211V-0 to 211V-2 of the user LPARs #0 to #2 the I/O access should be made.

For example, when the user OS #1 is making I/O access with the I/O_OS #1 through the virtual SCSI 211V-0 on the user LPAR #1, the arbiter 34 places access from other user OSs #0 and #2 (the user LPARs #0 and #2) in the wait state. Then, after the I/O access from the user OS #1 has ended, the arbiter 34 accepts I/O access from other user OS #0 or #2.

Thus, the arbiters 34 provided in the I/O_OSs selectively process I/O access requests from the plurality of user OSs #0 to #2 to allow the plurality of user OSs #0 to #2 to share a single I/O device (I/O LPAR).

### Fourth Embodiment

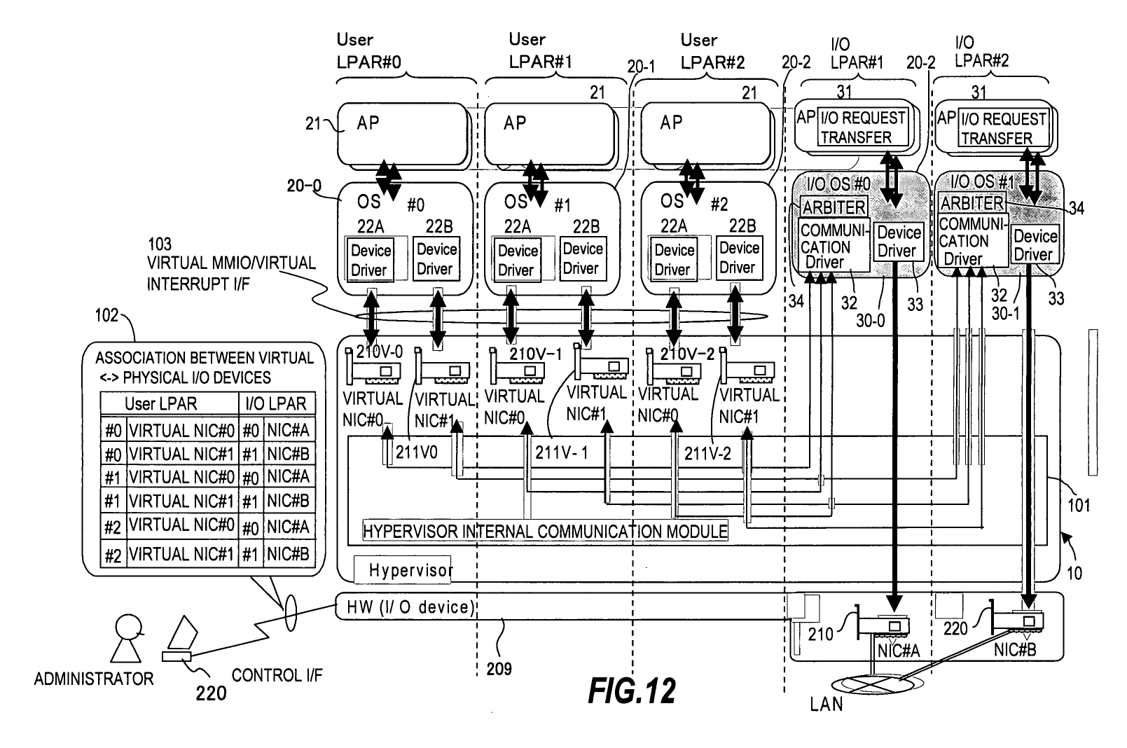

FIG. 12 shows a fourth embodiment, where, in the configuration of the third embodiment, a second network adapter NIC 220, instead of the SCSI 211, is shared by the three user OSs #0 to #2. This is an example in which I/O devices of the same type are shared by a plurality of user OSs, where the same components as those of the third embodiment are shown at the same reference characters and are not described here again.

In the fourth embodiment, the I/O LPAR #1 has the NIC 220 (the NIC #B in FIG. 12) and the I/O_OS #1 makes I/O access with the NIC 220.

In the I/O device table 102, the I/O LPAR #0 having the NIC 210 and the I/O LPAR #1 having the NIC 220 are allocated to each of the user LPARs #0 to #2.

According to the allocation of the I/O LPARs #0 and #1 in the I/O device table 102, the hypervisor 10 creates, for the user LPARs #0 to #2, virtual NICs 210V-0 to 210V-2 as virtual devices 103 that correspond to the NIC 210 (the NIC #A in FIG. 12) and also creates virtual NICs 220V-0 to 220V-2 that correspond to the NIC 220 (the NIC #B in FIG. 12).

Then, device drivers 22A and 22B that correspond to the virtual NICs 210V-0 to 210V-2 and the virtual NIC s 220V-0 to 220V-2 are respectively incorporated in the user OSs #0 to #2.

In the I/O_OS #0 on the I/O LPAR #0 that makes I/O access to the NIC 210, the arbiter 34 functions to determine with which of the virtual NICs 210V-0 to 210V-2 of the user LPARs #0 to #2 the I/O access should be made.

In the I/O_OS #1 on the I/O LPAR #1 that makes I/O access to the NIC 220, the arbiter 34 functions to determine with which of the virtual NICs 220V-0 to 220V-2 of the user LPARs #0 to #2 the I/O access should be made.

As in the third embodiment, for example, when the user OS #0 is making I/O access with the I/O_OS #0 through the virtual NIC 210V-0 on the user LPAR #0, the arbiters 34 of the I/O_OSs #0 and #1 place access from other user OSs #1 and #2 (the user LPARs #1 and #2) in the wait state. Then, after the I/O access from the user OS #0 has ended, the arbiters 34 accept I/O access from other user OS #1 or #2.

Thus, the arbiters 34 provided in the I/O_OSs selectively process I/O access requests from the plurality of user OSs #0 to #2 to allow the plurality of user OSs #0 to #2 to share a plurality of I/O devices (I/O LPARs) of the same kind.

While the embodiments above have shown configurations in which I/O devices and I/O LPARs are in a one-to-one correspondence, a plurality of I/O devices may be grouped as an I/O group, and the I/O group may be provided to a user LPAR as a single I/O LPAR. For example, the NIC 210 and the SCSI 211 may be contained in the single user LPAR #0 and the I/O_OS #0 may process the I/O access.

While the present invention has been described in detail and pictorially in the accompanying drawings, the present invention is not limited to such detail but covers various obvious modifications and equivalent arrangements, which fall within the purview of the appended claims.

What is claimed is:

1. An I/O device control method for allocating each of a plurality of I/O devices connected to a computer to one or more of a plurality of logical partitions constructed on a computer control program, the method comprising the steps of:
having the control program set at least one of the plurality of logical partitions as a logical user partition provided to a user;
setting at least another one of the plurality of logical partitions as a logical I/O partition for controlling an I/O device;
allocating the I/O device to the logical I/O partition; and
setting an association between the logical user partition and the logical I/O partition.

2. The I/O device control method according to claim 1, further comprising the steps of:
booting a user OS on the logical user partition;
booting, on the logical I/O partition, an I/O OS for accessing the I/O device; and
performing communication between the user OS and the I/O OS based on the association.

3. The I/O device control method according to claim 2, wherein the step of setting the association between the logical user partition and the logical I/O partition comprises the step of setting an association between the physical I/O device allocated to the logical I/O partition and a virtual I/O device set on the logical user partition.

4. The I/O device control method according to claim 3, further comprising the step of providing the virtual I/O device on the logical user partition to which the user OS belongs, on the basis of the association between the logical user partition and the logical I/O partition,
wherein the step of performing communication between the user OS and the I/O OS based on the association comprises the steps of:
causing the user OS to access the virtual I/O device; and
transferring the access from the virtual I/O device to the I/O OS.

5. The I/O device control method according to claim 4, wherein the virtual I/O device is provided by a virtual memory mapped I/O or a virtual I/O register.

6. The I/O device control method according to claim 2, further comprising the steps of:
monitoring operation of the I/O OS; and
when detecting a halt of the I/O OS, rebooting the I/O OS.

7. The I/O device control method according to claim 6, further comprising the step of, when detecting a halt of the I/O OS, obtaining a log about the I/O OS.

8. The I/O device control method according to claim 3, further comprising the steps of:
monitoring for a hot plugging of an I/O device;
when detecting a new I/O device, allocating the I/O device to the logical I/O partition;
allocating that logical I/O partition to the logical user partition;
providing a virtual I/O device for the new I/O device to the logical user partition; and
notifying the user OS of the logical user partition about the addition of the I/O device.

9. The I/O device control method according to claim 3, further comprising the steps of:
monitoring for a hot removal of any of the I/O devices;
when detecting a hot removal, deleting that I/O device from the logical I/O partition;
from the association between the logical user partition and the logical I/O partition, specifying which user OS uses the logical I/O partition from which the I/O device has been deleted;
in the logical user partition of the specified user OS, deleting the virtual I/O device that corresponds to the deleted I/O device; and
notifying the user OS of the deletion of the corresponding virtual I/O device.

10. The I/O device control method according to claim 1, wherein the step of allocating the I/O device to the logical I/O partition comprises the steps of:
grouping a plurality of I/O devices into a group; and
creating an independent logical I/O partition for the group.

11. A virtual machine system created by dividing a physical computer into a plurality of logical partitions and by running OSs on the logical partitions, the virtual machine system comprising a hypervisor that controls allocation of resources of the physical computer to the logical partitions,
wherein the hypervisor comprising:
a logical user partition setting module that sets a logical user partition to be provided to a user;
a logical I/O partition setting module that sets a logical I/O partition for controlling an I/O device of the physical computer;
an I/O device allocation module that allocates the I/O device to the logical I/O partition; and
an I/O device table that sets an association between the logical user partition and the logical I/O partition.

12. The virtual machine system according to claim 11, wherein
the logical user partition setting module controls a user OS that the user uses,
the logical I/O partition setting module controls an I/O OS that accesses the I/O device allocated, and
the hypervisor comprises an internal communication module that performs communication between the user OS and the I/O OS based on a setting of the I/O device table.

13. The virtual machine system according to claim 12, wherein the logical user partition setting module comprises a virtual device providing module that provides, based on the setting of the I/O device table, a virtual I/O device that corresponds to the physical I/O device of the logical I/O partition allocated to the logical user partition.

14. The virtual machine system according to claim 12, wherein
the logical I/O partition setting module comprises an I/O OS monitoring module that detects a condition of operation of the I/O OS, and
the I/O OS monitoring module reboots the I/O OS when detecting a halt of the I/O OS.

15. The virtual machine system according to claim 12, wherein
the logical I/O partition setting module comprises an I/O device monitoring section that detects an I/O device hot plugging or an I/O device hot removal, and
when an I/O device hot plugging or an I/O device hot removal occurs, the I/O device monitoring module updates the setting of the I/O device table based on the setting of the I/O device table.
